(19) United States
(12) Patent Application Publication
(10) Pub. No.: US 2017/0006457 A1
(43) Pub. Date: Jan. 5, 2017

(54) USER TERMINAL, RADIO BASE STATION, RADIO COMMUNICATION SYSTEM AND RADIO COMMUNICATION METHOD

(71) Applicant: NTT DOCOMO, INC., Tokyo (JP)

(72) Inventors: Hiroki Harada, Tokyo (JP); Qun Zhao, Beijing (CN); Yongbo Zeng, Beijing (CN); Yongsheng Zhang, Beijing (CN)

(73) Assignee: NTT DOCOMO, INC., Tokyo (JP)

(21) Appl. No.: 15/114,865

(22) PCT Filed: Jan. 22, 2015
(86) PCT No.: PCT/JP2015/051600

§ 371 Date: Jul. 28, 2016

(30) Foreign Application Priority Data
Jan. 30, 2014 (JP) 2014-016064

(51) Int. Cl. H04W 8/00; H04L 12/26; H04W 72/04

(52) U.S. Cl. CPC H04W 8/005; H04W 72/0453; H04W 72/0413; H04W 72/0473; H04L 43/16; H04W 88/08

(57) ABSTRACT

To reduce interference (in-band emission) to PUCCH by an inter-terminal discovery signal when the PUCCH and inter-terminal discovery signal are subjected to frequency division multiplexing, a user terminal of the present invention performs frequency division multiplexing on the PUCCH and the inter-terminal discovery signal to transmit. Further, the user terminal of the invention is provided with a reception section that receives limited resource region information indicative of a limited resource region obtained by removing an adjacent region of a frequency resource region where the PUCCH is allocated from a radio base station, a determining section that determines a distance between the radio base station and the user terminal, and a selecting section that selects an allocation resource of the inter-terminal discovery signal from the limited resource region when the determining section determines that the distance is relatively close.

### TECHNICAL FIELD

The present invention relates to a user terminal, radio base station, radio communication system and radio communication method in the next-generation mobile communication system where inter-terminal signal transmission/reception is performed.

### BACKGROUND ART

In UMTS (Universal Mobile Telecommunications System) networks, for the purpose of higher data rates, low delay and the like, LTE (Long Term Evolution) has been specified (Non-patent Document 1).

In the LTE and a successor system (for example, also referred to as LTE-Advanced, FRA (Future Radio Access), 4G and the like) to LTE, radio communication systems have also been studied to support inter-terminal (D2D: Device-to-Device) signal transmission/reception in which terminals transmit and receive signals to/from one another by bypassing a radio base station (for example, Non-patent Document 2).

The inter-terminal signal transmission/reception includes inter-terminal discovery (D2D discovery) where user terminals mutually discover another user terminal by bypassing a radio base station, inter-terminal communication (D2D communication) where discovered user terminals mutually transmit and receive communication signals such as data to/from one another by bypassing a radio base station, and the like.

### CITATION LIST

### Non-Patent Literature

Non-Patent Literature 1: 3GPP TR 36.814 “E-UTRA Further advancements for E-UTRA physical layer aspects”
Non-Patent Literature 1: “Key drivers for LTE success: Services Evolution”, 2011 September, 3GPP, Internet URL: http://www.3gpp.org/ftp/Information/presentations/presentations_2011/2011_09_LTE_Asia/2011_LTE-Asia_3GPP_Service_evolution.pdf

### SUMMARY OF INVENTION

### Technical Problem

In the radio communication system where inter-terminal discovery is performed, it is conceived that an uplink control channel (PUCCH: Physical Uplink Control Channel) and inter-terminal discovery signal are subjected to frequency division multiplexing (FDM: Frequency Division Multiplexed) in the same subframe. Herein, the inter-terminal discovery signal (also referred to as discovery signal, D2D discovery signal, DS and the like) is a signal for causing another user terminal to discover the terminal by bypassing a radio base station.

However, when the PUCCH and inter-terminal discovery signal are subjected to frequency division multiplexing, there is the risk that interference (in-band emission) to the PUCCH by the inter-terminal discovery signal increases.

The present invention was made in view of such a respect, and it is an object of the invention to provide a user terminal, radio base station, radio communication system and radio communication method for enabling interference (in-band emission) to a PUCCH by an inter-terminal discovery signal to be reduced when the PUCCH and inter-terminal discovery signal are subjected to frequency division multiplexing.

### Solution to Problem

A user terminal according to the present invention is a user terminal that performs frequency division multiplexing on an uplink control channel and an inter-terminal discovery signal to transmit, and is characterized by being provided with a reception section that receives limited resource region information indicative of a limited resource region obtained by removing an adjacent region of a frequency resource region where the uplink control channel is allocated from a radio base station, a determining section that determines a distance between the radio base station and the user terminal, and a selecting section that selects an allocation resource of the inter-terminal discovery signal from the limited resource region, when the determining section determines that the distance is relatively close.

### Advantageous Effects of Invention

According to the present invention, when the PUCCH and inter-terminal discovery signal are subjected to frequency division multiplexing, it is possible to reduce interference (in-band emission) to the PUCCH by the inter-terminal discovery signal.

### BRIEF DESCRIPTION OF DRAWINGS

FIG. 1 is an explanatory diagram of frequency division multiplexing of PUCCH and discovery signal;

FIG. 2 contains explanatory diagrams of in-band emission;

FIG. 3 contains explanatory diagrams of interference (in-band emission) to the PUCCH by the discovery signal;

FIG. 4 contains explanatory diagrams of a radio communication method according to Aspect 1 of the present invention;

FIG. 5 contains explanatory diagrams of a radio communication method according to Aspect 2.1 of the invention;

FIG. 6 contains explanatory diagrams of a radio communication method according to Aspect 2.2 of the invention;

FIG. 7 contains explanatory diagrams of a radio communication method according to Aspect 2.3 of the invention;

FIG. 8 is a schematic diagram showing one example of a radio communication system according to this Embodiment;

FIG. 9 is an entire configuration diagram of a radio base station according to this Embodiment;

FIG. 10 is an entire configuration diagram of a user terminal according to this Embodiment;

FIG. 11 is a detailed configuration diagram of the radio base station according to this Embodiment; and

FIG. 12 is a detailed configuration diagram of the user terminal according to this Embodiment.

### DESCRIPTION OF EMBODIMENTS

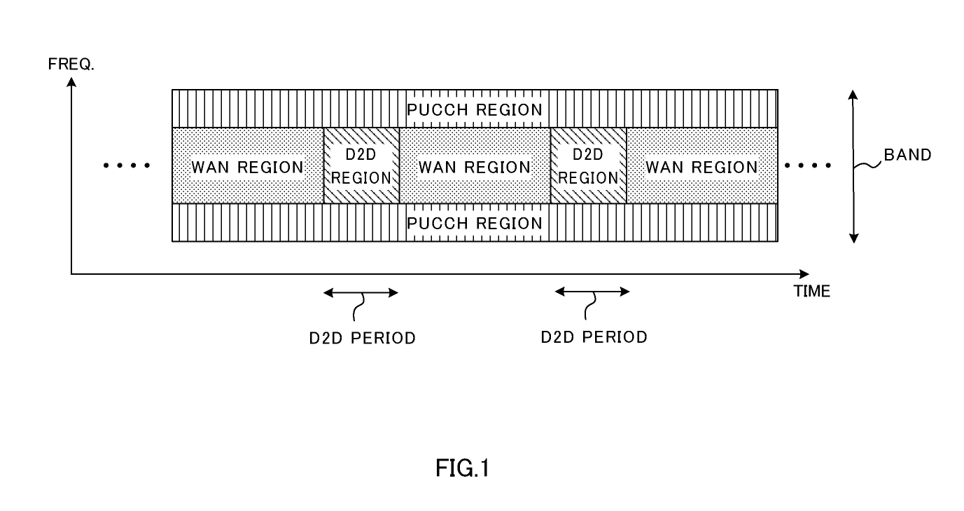

FIG. 1 is an explanatory diagram of frequency division multiplexing of an uplink control channel (PUCCH) and discovery signal. The discovery signal (also referred to as D2D signal, D2D discovery signal, DS and the like) is an inter-terminal discovery signal for causing another user terminal to discover the terminal by bypassing a radio base station, and may include identification information of the terminal.

Further, the PUCCH is allocated inside a part of frequency resource region (hereinafter, referred to as PUCCH region) inside a band. Herein, the band is an uplink band in a frequency division duplex (FDD) scheme, while being a band used in uplink subframes in a time division duplex (TDD) scheme. The following description will exemplify the case where the PUCCH region is provided in opposite end regions of the band, but the present invention is not limited thereto. The PUCCH region may be provided in any manner, as long as the region is a part of frequency resource region inside the band.

As shown in FIG. 1, the PUCCH region is allocated not only in a transmission period of a WAN (Wide Area Network) signal (for example, uplink shared channel (PUSCH: Physical Uplink Shared Channel)) from a user terminal to a radio base station, but also in a transmission period (hereinafter, referred to as D2D period) of a periodical discovery signal.

This is because it is necessary to allocate the PUCCH also in the D2D period, in order to transmit receipt confirmation information (ACK, NACK and the like) and channel quality information (for example, CSI: Channel State Information) of a downlink signal transmitted in the D2D period to the radio base station as feedback without delay. In addition, for example, the D2D period is comprised of a plurality of subframes.

Thus, it is conceived that the discovery signal is allocated in a radio resource inside the resource region (D2D region) except the PUCCH region in the D2D period, and is frequency division multiplexed with the PUCCH.

In addition, for example, the radio resource (hereinafter, referred to as allocation resource) where the discovery signal is allocated inside the D2D region is at least a single resource block (PRB: Physical Resource Block), PRB pair and the like. The allocation resource may be selected autonomously by a user terminal (Type-1, collision type), or may be notified to a user terminal from a radio base station (Type-2, non-collision type).

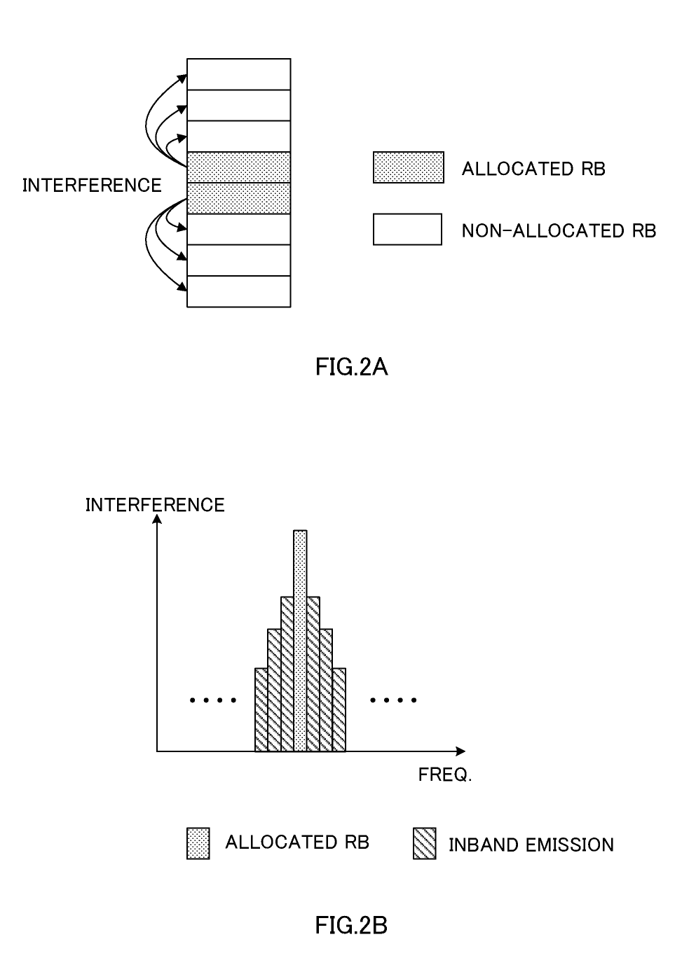

FIG. 2 contains explanatory diagrams of in-band emission. In addition, in FIG. 2, it is assumed that a resource block is used as a unit of the allocation resource, but the invention is not limited thereto. As shown in FIG. 2A, the in-band emission is interference to other near resource blocks (Non-allocated RB) in the frequency domain from a resource block (Allocated RB) where a desired signal is allocated.

An interference amount by in-band emission is determined by the function of a frequency distance (offset, the number of resource blocks) from the resource block with the desired signal allocated. As shown in FIG. 2B, the interference amount increases in a resource block with frequencies nearer the resource block with the desired signal allocated.

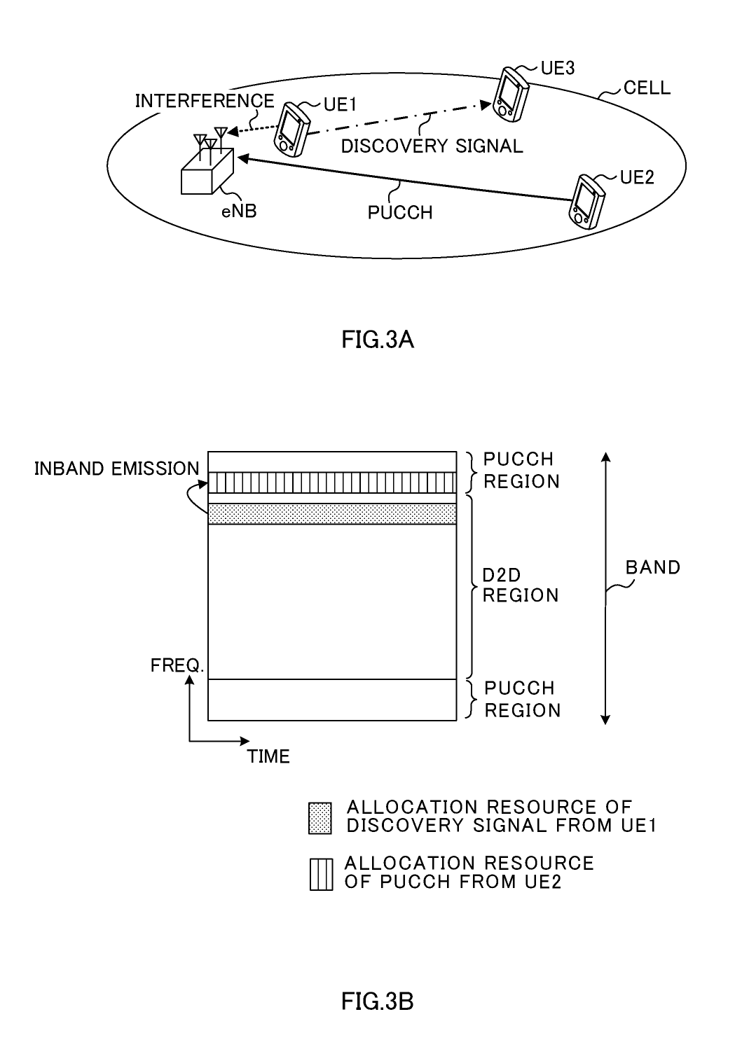

FIG. 3 contains explanatory diagrams of interference (in-band emission) to the PUCCH by the discovery signal. In FIG. 3A, it is assumed that user terminals (UE: User Equipment) 1 to 3 are positioned inside a cell formed by a radio base station (eNB: eNodeB), the user terminal 1 near (center portion of the cell (hereinafter, referred to as cell center portion)) the radio base station transmits the discovery signal, and that the user terminal 2 in an edge portion (hereinafter, referred to as cell edge portion) of the cell transmits the PUCCH to the radio base station.

In FIG. 3A, transmission power of the PUCCH from the user terminal 2 is controlled to be received in the radio base station with desired reception quality. On the other hand, transmission power of the discovery signal from the user terminal 1 is not controlled unlike the PUCCH, and is transmitted with predetermined transmission power (for example, maximum transmission power). This is because the user terminal 1 that transmits the discovery signal is not able to beforehand know the distance from the user terminal 3 that receives the discovery signal.

In FIG. 3A, as shown in FIG. 3B, it is assumed that the discovery signal from the user terminal 1 is allocated near the allocation resource of the PUCCH from the user terminal 2. As described above, since transmission power of the discovery signal from the user terminal 1 is not controlled, in the case as shown in FIG. 3B, by in-band emission of the discovery signal from the user terminal 1, the PUCCH from the user terminal 2 received in the radio base station undergoes large interference.

Thus, when the PUCCH allocated in the PUCCH region and the discovery signal are subjected to frequency division multiplexing, there is the risk that interference (in-band emission) to the PUCCH by the discovery signal increases. Therefore, the inventors of the present invention conceived reducing interference to the PUCCH by the discovery signal by limiting the allocation resource of the discovery signal (Aspect 1) or limiting transmission power thereof (Aspect 2), and arrived at the invention.

Radio communication methods according to the present invention will be described below in detail. In addition, the case will be described below where the discovery signal that is an inter-terminal discovery signal and PUCCH are subjected to frequency division multiplexing, and the invention is applicable as appropriate also to the case of performing frequency division multiplexing on a signal (inter-terminal transmission/reception signal) transmitted/received between terminals by bypassing a radio base station and the PUCCH.

### (Aspect 1)

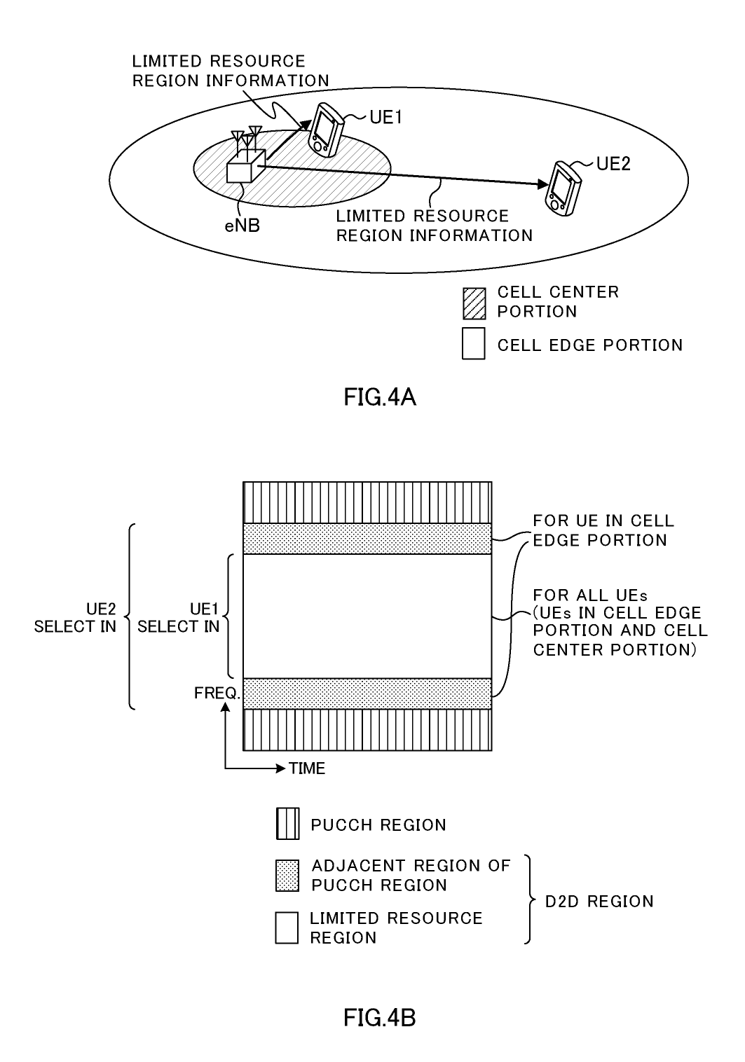

The radio communication method according to Aspect 1 will be described with reference to FIG. 4. In the radio communication method according to Aspect 1, resource regions for enabling the allocation resource of the discovery signal to be selected are limited, corresponding to a distance from a radio base station. Specifically, the radio base station transmits limited resource region information indicative of a limited resource region (described later) to a user terminal. The user terminal determines a distance (position of the user terminal inside the cell) between the radio base station and the user terminal. When it is determined that the distance is relatively close (the user terminal is positioned in the cell center portion), the user terminal selects the allocation resource of the discovery signal from the above-mentioned limited resource region.

FIG. 4 contains explanatory diagrams of the radio communication method according to Aspect 1. In FIG. 4A, it is assumed that user terminals 1 and 2 are positioned inside a cell formed by a radio base station. Particularly, in FIG. 4A, it is assumed that the user terminal 1 is positioned in the cell center portion near the radio base station, and that the user terminal 2 is positioned in the cell edge portion at a distance from the radio base station. In addition, FIG. 4A is only one example, and the number of user terminals and positions of the user terminals inside the cell are not limited thereto.

As shown in FIG. 4A, the radio base station transmits the limited resource region information indicative of the limited resource region (described later) to the user terminals 1 and 2. For example, the radio base station transmits the limited resource region information with broadcast information such as SIB (System Information Block), downlink control channel (PDCCH: Physical Downlink Control Channel, EPDCCH: Enhanced Physical Downlink Control Channel), higher layer signaling such as RRC (Radio Resource Control) and the like.

As shown in FIG. 4B, the limited resource region is a resource region obtained by removing adjacent regions of the PUCCH region. Further, when the PUCCH region is allocated in opposite end regions of the band, the limited resource region may be within a predetermined range from the center frequency (band center) of the band, and a resource region obtained by removing the adjacent regions of the PUCCH region. The limited resource region includes at least a single radio resource (for example, resource block and PRB pair) in the time and/or frequency domain to be formed. The limited resource region information may be an index (for example, resource block index, PRB index and the like) of the radio resource forming the limited resource region.

Similarly, the adjacent region of the PUCCH region shown in FIG. 4B includes at least a single radio resource (for example, resource block and PRB pair) in the time and/or frequency domain to be formed. Further, the resource region formed of the limited resource region and adjacent regions of the PUCCH region is also called the D2D region.

In FIG. 4A, the user terminal 1 determines a distance (position of the user terminal 1 in the cell) from the radio base station. Specifically, the user terminal 1 determines the distance from the radio base station (whether or not the user terminal 1 is positioned in the cell center portion), based on a comparison result between a predetermined threshold and downlink signal intensity (for example, RSRP: Reference Signal Received Power) from the radio base station, path loss between the radio base station and the user terminal 1 or the like. In addition, the path loss is calculated based on downlink signal intensity from the radio base station, and transmission power of the radio base station.

For example, the user terminal 1 may determine that the distance from the radio base station is relatively far (positioned in the cell edge portion) when the above-mentioned path loss is larger than a predetermined threshold, and may determine that the distance from the radio base station is relatively close (positioned in the cell center portion) when the above-mentioned path loss is the predetermined threshold or less. Alternatively, the user terminal 1 may determine that the distance from the radio base station is relatively far (positioned in the cell edge portion) when the downlink signal intensity is smaller than a predetermined threshold, and may determine that the distance from the radio base station is relatively close (positioned in the cell center portion) when the downlink signal intensity is the predetermined threshold or more.

In addition, determination criteria information (for example, predetermined threshold with respect to the path loss or downlink signal intensity and the like) used in the above-mentioned determination may be notified from the radio base station to the user terminal, using broadcast information such as SIB, downlink control channel (PDCCH or EPDCCH), higher layer signaling such as RRC signaling and the like, or may be beforehand specified.

Based on the determination criterion as described above, the user terminal 1 in FIG. 4A determines that the distance from the radio base station is relatively close (positioned in the cell center portion). In this case, as shown in FIG. 4B, the user terminal 1 selects the allocation resource of the discovery signal from the limited resource region. The user terminal 1 transmits the discovery signal using the selected allocation resource. In addition, the user terminal 1 may autonomously select the allocation resource of the discovery signal from the limited resource region.

In FIG. 4A, since the user terminal 1 is closer to the radio base station than the user terminal 2, it is conceived that the discovery signal of the user terminal 1 gives high interference to the PUCCH received in the radio base station, as compared with the discovery signal from the user terminal 2. Therefore, as shown in FIG. 4B, the user terminal 1 selects the allocation resource of the discovery signal from the limited resource region spaced apart from the PUCCH region. By this means, also in the case of not performing transmission power control of the discovery signal (i.e. also in the case where the discovery signals of the user terminals 1 and 2 are transmitted with the same transmission power), it is possible to reduce interference given to the PUCCH received in the radio base station from the discovery signal of the user terminal 1.

On the other hand, the user terminal 2 in FIG. 4B determines that the distance from the radio base station is relatively far (positioned in the cell edge portion). In this case, as shown in FIG. 4B, the user terminal 2 selects the allocation resource of the discovery signal from the entire D2D region formed of the limited resource region and adjacent regions of the PUCCH region. The user terminal 2 transmits the discovery signal using the selected allocation resource. In addition, the user terminal 2 is capable of autonomously selecting the allocation resource of the discovery signal from the entire D2D region.

In FIG. 4A, it is conceived that the discovery signal of the user terminal 2 gives low interference to the PUCCH received in the radio base station, as compared with the discovery signal from the user terminal 1. Therefore, the user terminal 2 is capable of selecting the allocation resource of the discovery signal not only from the limited resource region spaced apart from the PUCCH region, but also from the adjacent regions of the PUCCH region.

As described above, in the radio communication method according to Aspect 1, in the case where the distance between the radio base station and the user terminal is relatively close (the user terminal is positioned in the cell center portion), the allocation resource of the discovery signal is selected from the limited resource region spaced apart from the PUCCH region, and it is thereby possible to reduce interference to the PUCCH by the discovery signal.

### (Aspect 2)

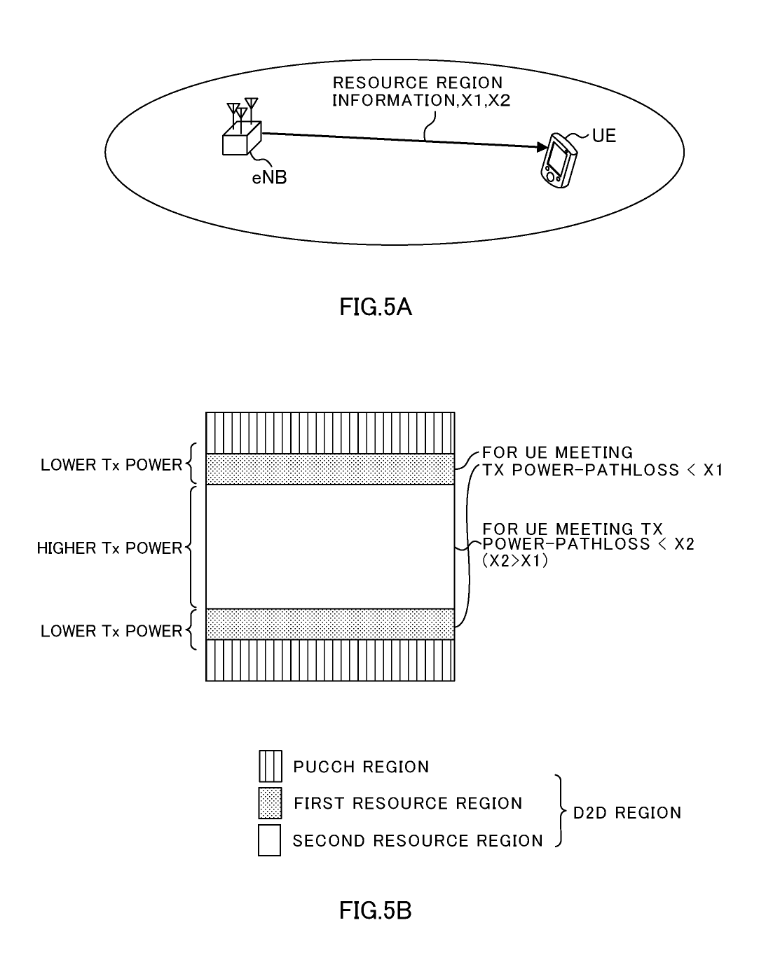

Referring to FIGS. 5 to 7, the radio communication method according to Aspect 2 will be described with emphasis on differences from Aspect 1. In the radio communication method according to Aspect 2, transmission power of the discovery signal is limited, corresponding to the allocation resource where the discovery signal is allocated (more specifically, a frequency distance between the allocation resource of the discovery signal and the PUCCH region).

Specifically, the radio base station transmits resource region information indicative of a plurality of resource regions (also referred to as resource set) with different frequency distances from the PUCCH region to a user terminal. The user terminal selects the allocation resource of the discovery signal from the plurality of resource regions. The user terminal transmits the discovery signal with transmission power associated with the resource region including the selected allocation resource.

Herein, transmission power associated with the resource region including the above-mentioned allocation resource may be calculated based on maximum allowable power determined for each resource region (Aspect 2.1), may be calculated based on the frequency distance from the PUCCH region to the above-mentioned allocation resource (Aspect 2.2), or may be calculated based on transmission power of the PUCCH or the PUSCH and offset determined for each resource region (Aspect 2.3).

### (Aspect 2.1)

FIG. 5 contains explanatory diagrams of the radio communication method according to Aspect 2.1. In FIG. 5A, it is assumed that a user terminal is positioned inside a cell formed by a radio base station. In addition, FIG. 5A is only one example, and the number of user terminals and positions of the user terminals inside the cell are not limited thereto.

As shown in FIG. 5A, the radio base station transmits the resource region information indicative of a plurality of resource regions (also referred to as resource set) with different frequency distances from the PUCCH region to the user terminal. For example, the radio base station transmits the resource region information with broadcast information such as SIB, downlink control channel (PDCCH, EPDCCH), higher layer signaling such as RRC signaling and the like.

As shown in FIG. 5B, a plurality of resource regions includes first resource regions adjacent to the PUCCH region (i.e. the frequency distance from the PUCCH region is relatively close) and a second resource region that is not adjacent to the PUCCH region (i.e. the frequency distance from the PUCCH region is relatively far.) In addition, FIG. 5B is only illustrative, and three or more resource regions with different frequency distances from the PUCCH region may be provided.

Further, each of the first regions and second region includes at least a single radio resource (for example, resource block and PRB pair) in the time and/or frequency domain to be formed. The resource region information may be an index (for example, resource block index, PRB index and the like) of the radio resource forming each of the first regions and second region.

As shown in FIG. 5B, maximum allowable power of the discovery signal is determined for each resource region. For example, since the first resource region is adjacent to the PUCCH region, relatively low maximum allowable power X1 is determined. On the other hand, since the second resource region is not adjacent to the PUCCH region, maximum allowable power X2 higher than maximum allowable power X1 of the first resource region is determined.

In addition, maximum allowable power X1, X2 for each resource region may be notified from the radio base station to the user terminal, using broadcast information such as SIB, downlink control channel (PDCCH, EPDCCH), higher layer signaling such as RRC signaling and the like, or may be beforehand specified.

The user terminal selects the allocation resource of the discovery signal from a plurality of resource regions indicated by the resource region information. Herein, as in Aspect 1, the user terminal may select the allocation resource of the discovery signal from the resource region determined based on the distance (position of the user terminal inside the cell) from the radio base station. Alternatively, the user terminal may select the allocation resource of the discovery signal from a plurality of resource regions on an arbitrary condition (for example, autonomously or randomly).

In addition, as in Aspect 1, the distance between the user terminal and the radio base station is determined, based on a comparison result between a predetermined threshold and downlink signal intensity (for example, RSRP: Reference Signal Received Power) from the radio base station, path loss between the radio base station and the user terminal 1 or the like. The detailed determination criteria are the same as in Aspect 1, and therefore, descriptions thereof are omitted herein.

Further, based on maximum allowable power of the resource region including the selected allocation resource as described above, the user terminal calculates transmission power of the discovery signal. Specifically, the user terminal may calculate transmission power of the discovery signal, based on the maximum allowable power and the distance (position of the user terminal inside the cell) from the radio base station, or may use the maximum allowable power of the selected resource region without modification. The user terminal transmits the discovery signal using calculated transmission power.

For example, in FIG. 5B, in the case of selecting the allocation resource of the discovery signal from the first resource region, the user terminal calculates transmission power of the discovery signal, based on maximum allowable power X1 of the first resource region and the distance (for example, path loss) from the radio base station. Specifically, the user terminal may set transmission power at the sum of maximum allowable power X1 and path loss, so that reception power of the signal in the radio base station is lower than maximum allowable power X1 (or, maximum allowable power X1 or less).

On the other hand, in FIG. 5B, in the case of selecting the allocation resource of the discovery signal from the second resource region, the user terminal calculates transmission power of the discovery signal, based on maximum allowable power X2 of the second resource region and the distance (for example, path loss) from the radio base station. Specifically, the user terminal may set transmission power at the sum of maximum allowable power X2 and path loss, so that reception power of the signal in the radio base station is lower than maximum allowable power X2 (or, maximum allowable power X2 or less).

As described above, in the radio communication method according to Aspect 2.1, the user terminal selects the allocation resource of the discovery signal from a plurality of resource regions indicated by the resource region information, and based on maximum allowable power of the resource region including the selected allocation resource, calculates transmission power of the discovery signal. By this means, since transmission power of the resource region adjacent to the PUCCH region is calculated relatively low, it is possible to reduce interference to the PUCCH.

### (Aspect 2.2)

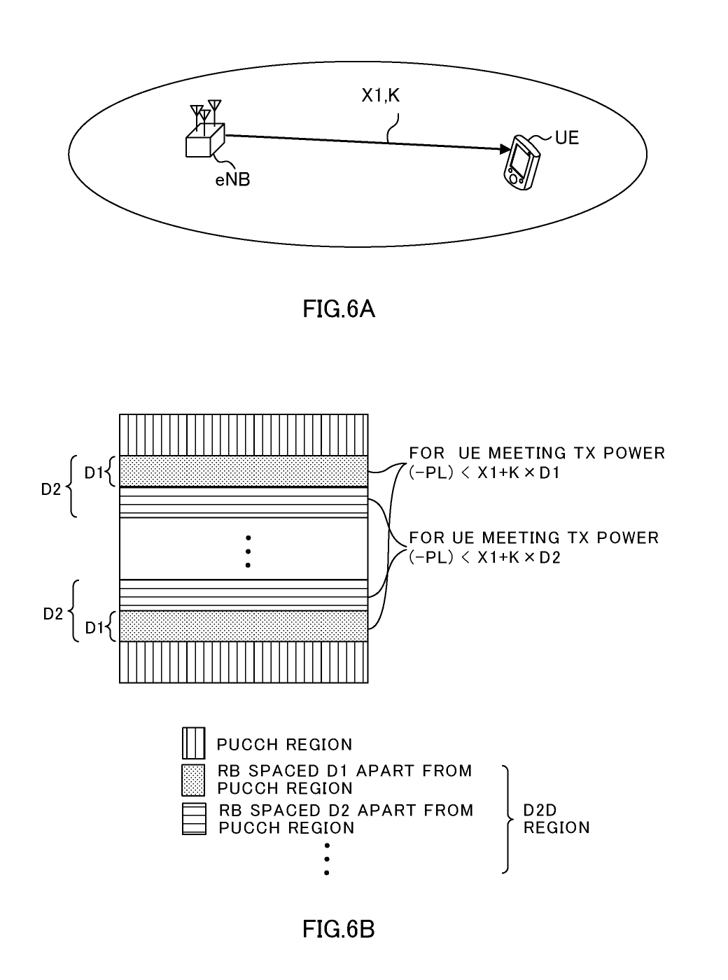

FIG. 6 contains explanatory diagrams of the radio communication method according to Aspect 2.2. In FIG. 6A, it is assumed that a user terminal is positioned inside a cell formed by a radio base station. In addition, FIG. 6A is only one example, and the number of user terminals and positions of the user terminals inside the cell are not limited thereto.

As shown in FIG. 6A, the radio base station transmits a control parameter of transmission power of the discovery signal to the user terminal. For example, the radio base station transmits the control parameter with broadcast information such as SIB, downlink control channel (PDCCH, EPDCCH), higher layer signaling such as RRC and the like. As shown in FIG. 6A, the control parameter includes predetermined transmission power X1 and predetermined coefficient K as described later.

As shown in FIG. 6B, in Aspect 2.2, the D2D region with the PUCCH region removed includes a plurality of frequency resources. Herein, the frequency resource is a radio resource in the frequency domain, and for example, is a resource block or PRB pair. As an example, the case will be described where the unit of frequency resource is a resource block (RB).

The user terminal selects the frequency resource (hereinafter, referred to as allocation resource) to allocate the discovery signal from the D2D region. Herein, the user terminal may select the allocation resource of the discovery signal based on the distance (position of the user terminal inside the cell) from the radio base station. Alternatively, the user terminal may select the allocation resource of the discovery signal from the D2D region on an arbitrary condition (for example, autonomously or randomly).

Based on the frequency distance from the PUCCH region to the selected allocation resource and the control parameter (for example, predetermined transmission power X1, predetermined coefficient K) from the radio base station, the user terminal calculates maximum allowable power different for each selected allocation resource. The user terminal may calculate transmission power of the discovery signal, based on the maximum allowable power and the distance (for example, path loss) from the radio base station. Specifically, the user terminal may set transmission power at the sum of maximum allowable power and path loss, so that reception power of the discovery signal in the radio base station is maximum allowable power or less.

For example, in FIG. 6B, in the case where the user terminal selects a resource block (RB) spaced D1 apart from the PUCCH region as the allocation resource of the discovery signal, maximum allowable power is represented by (X1+K×D1). Herein, X1 is predetermined transmission power that is not dependent on the frequency distance from the PUCCH region, and is notified from the radio base station. Further, K is a predetermined coefficient, and is notified from the radio base station. Furthermore, D1 is the number of resource blocks from the PUCCH region. The user terminal sets transmission power at the sum of maximum allowable power (X1+K×D1) and path loss, so that reception power of the discovery signal in the radio base station is lower than maximum allowable power (X1+K×D1) (or, is maximum allowable power (X1+K×D1) or less).

On the other hand, in FIG. 6B, in the case where the user terminal selects a resource block (RB) spaced D2 apart from the PUCCH region as the allocation resource of the discovery signal, maximum allowable power is represented by (X1+K×D2). X1 and K are as described above, and D2 is the number of resource blocks from the PUCCH region. The user terminal sets transmission power at the sum of maximum allowable power (X1+K×D2) and path loss, so that reception power of the discovery signal in the radio base station is lower than maximum allowable power (X1+K×D2) (or, is maximum allowable power (X1+K×D2) or less).

In FIG. 6B, since D1<D2, as a resource block farther from the PUCCH region is selected as the allocation resource of the discovery signal, maximum allowable power is calculated higher. As a result, as a resource block farther from the PUCCH region is selected as the allocation resource of the discovery signal, transmission power of the PUCCH discovery signal is higher.

As described above, in the radio communication method according to Aspect 2.2, the user terminal determines maximum allowable power based on the frequency distance from the PUCCH region to the allocation resource of the discovery signal, and based on the determined maximum allowable power, calculates transmission power of the discovery signal. By this means, as the allocation resource closer to the PUCCH region is selected, transmission power of the discovery signal is lower, and it is thereby possible to reduce interference to the PUCCH.

### (Aspect 2.3)

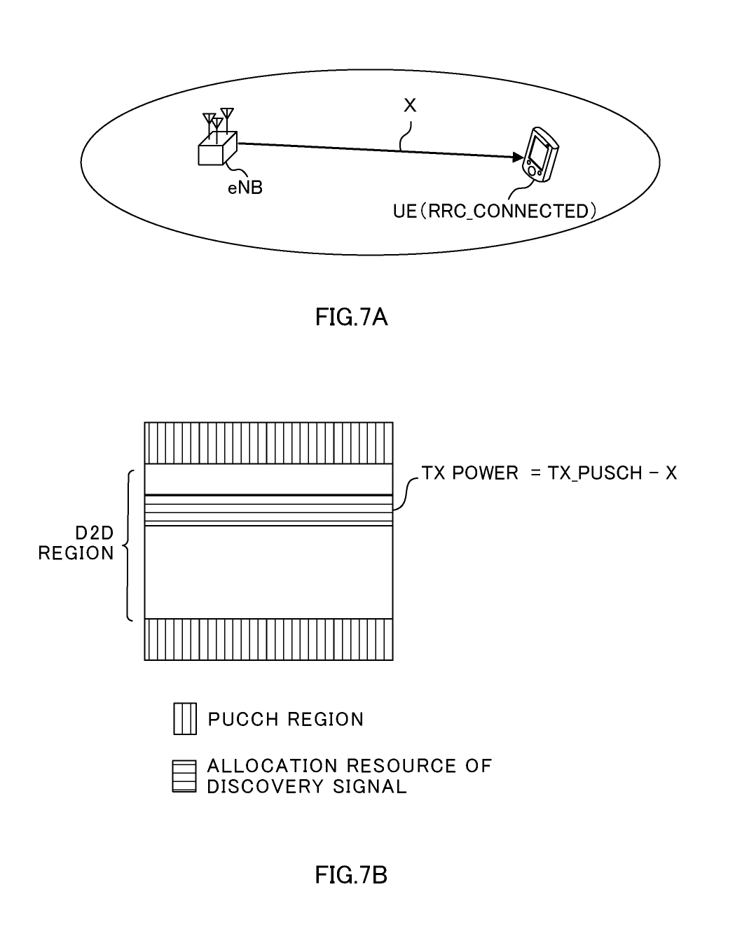

FIG. 7 contains explanatory diagrams of the radio communication method according to Aspect 2.3. In FIG. 7A, it is assumed that a user terminal is positioned inside a cell formed by a radio base station. Further, in FIG. 7A, it is assumed that the user terminal is in a state (RRC_connected state) (hereinafter, referred to as connected state) in which connection with the radio base station is connected. In addition, FIG. 7A is only one example, and the number of user terminals and positions of the user terminals inside the cell are not limited thereto.

As shown in FIG. 7A, the radio base station transmits a control parameter of transmission power of the discovery signal to the user terminal. For example, the radio base station transmits the control parameter with broadcast information such as SIB, downlink control channel (PDCCH, EPDCCH), higher layer signaling such as RRC signaling and the like. As shown in FIG. 7A, the control parameter includes transmission power offset X with respect to transmission power of the PUCCH or the PUSCH.

The transmission power offset X transmitted from the radio base station may be determined to a larger value in a resource region where the frequency distance from the PUCCH region is shorter, or may be determined to be a smaller value in a resource region where the frequency distance from the PUCCH region is longer.

The user terminal selects the frequency resource (hereinafter, referred to as allocation resource) to allocate the discovery signal from the D2D region. Herein, the user terminal may select the allocation resource of the discovery signal based on the distance (position of the user terminal inside the cell) from the radio base station. Alternatively, the user terminal may select the allocation resource of the discovery signal from the D2D region on an arbitrary condition (for example, autonomously or randomly).

Herein, the user terminal in the connected state (RRC_connected state) performs transmit power control of the PUCCH and/or the PUSCH based on the distance (path loss) from the radio base station. Then, the user terminal in the connected state calculates transmission power of the discovery signal, based on transmission power of the PUCCH or the PUSCH, and the transmission power offset X of the resource region including the allocation resource of the discovery signal.

Specifically, as shown in FIG. 7B, the user terminal in the connected state may subtract the transmission power offset X from transmission power (TX_PUSCH) of the PUSCH to calculate transmission power of the discovery signal. Further, although not shown in the figure, the user terminal in the connected state may subtract the transmission power offset X from transmission power of the PUCCH to calculate transmission power of the discovery signal.

Transmission power of the PUCCH and/or the PUSCH is beforehand controlled based on the distance (path loss) between the user terminal and the radio base station, so that target reception power in the radio base station is satisfied. Therefore, the path loss may not be used in calculation of the discovery signal in Aspect 2.3, unlike Aspects 2.1 and 2.2.

As described above, in the radio communication method according to Aspect 2.3, the user terminal calculates transmission power of the discovery signal, based on transmission power of the PUCCH or the PUSCH and transmission power offset X. By this means, since transmission power of the discovery signal is lower in a resource region closer to the PUCCH region, it is possible to reduce interference to the PUCCH.

### (Radio Communication System)

A radio communication system according to this Embodiment will be described below in detail. In the radio communication system, the radio communication methods according to Aspect 1 and Aspect 2 (including Aspects 2.1 to 2.3) are applied. In addition, the radio communication methods according to Aspects 1 and 2 may be applied alone or applied in combination thereof.

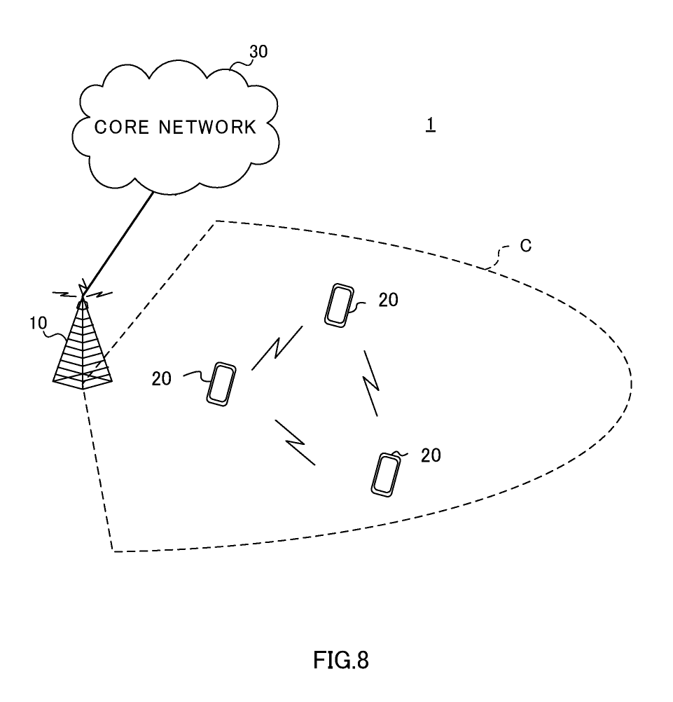

FIG. 8 is a schematic configuration diagram of the radio communication system according to this Embodiment. As shown in FIG. 8, the radio communication system 1 includes a radio base station 10 for forming a cell C, user terminals 20, and core network 30 to which the radio base station 10 is connected, and is comprised thereof. In addition, the numbers of the radio base stations 10 and user terminals 20 are not limited to those shown in FIG. 8.

The radio base station 10 is a radio base station having predetermined coverage. In addition, the radio base station 10 may be a macro base station (eNodeB (eNB), macro base station, collection node, transmission point, transmission/reception point) having relatively wide coverage, or may be a small base station (small base station, pico-base station, femto-base station, HeNB (Home eNodeB), RRH (Remote Radio Head), micro-base station, transmission point, transmission/reception point) having local coverage.

The user terminal 20 is a terminal supporting various types of communication schemes such as LTE, LTE-A and FRA, and may include a fixed communication terminal as well as the mobile communication terminal. The user terminal 20 performs uplink/downlink communications with the radio base station 10, and performs inter-terminal signal transmission/reception including inter-terminal discovery and inter-terminal communication with another user terminal 20.

Further, as downlink channels, in the radio communication system 1 are used a downlink shared channel (PDSCH: Physical Downlink Shared Channel) shared by user terminals 20, downlink control channels (PDCCH: Physical Downlink Control Channel, EPDCCH: Enhanced Physical Downlink Control Channel), broadcast channel (PBCH) and the like. User data, higher layer control information, and predetermined SIB (System Information Block) are transmitted on the PDSCH. Downlink control information (DCI) is transmitted on the PDCCH and EPDCCH. The EPDCCH is frequency division multiplexed with the PDSCH, and is also called the enhanced downlink control channel.

Furthermore, as uplink channels, in the radio communication system 1 are used an uplink shared channel (PUSCH: Physical Uplink Shared Channel) shared by user terminal 20, uplink control channel (PUCCH: Physical Uplink Control Channel) and the like. User data and higher layer control information is transmitted on the PUSCH. Still furthermore, in the radio communication system 1, on uplink, the discovery signal (inter-terminal discovery signal) to mutually detect terminals is transmitted between user terminals 20.

Moreover, in the radio communication system 1, as a duplex scheme, a frequency division duplex (FDD) scheme may be used, a time division duplex (TDD) scheme may be used, or both of the schemes may be used. Further, although not shown in the figure, when the macro base station and small base station are provided, the macro base station may use the FDD scheme, while the small base station may use the TDD scheme.

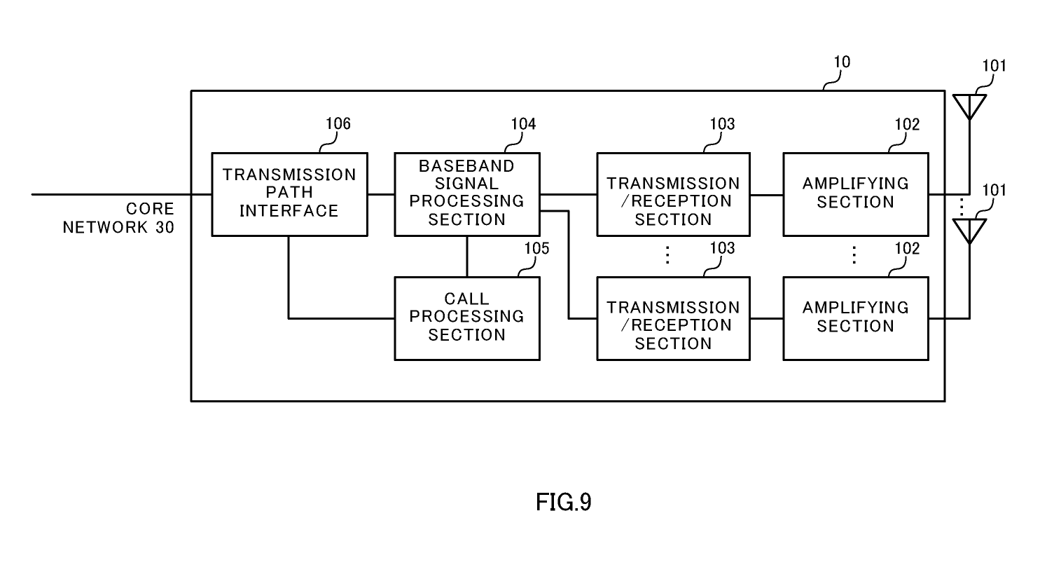

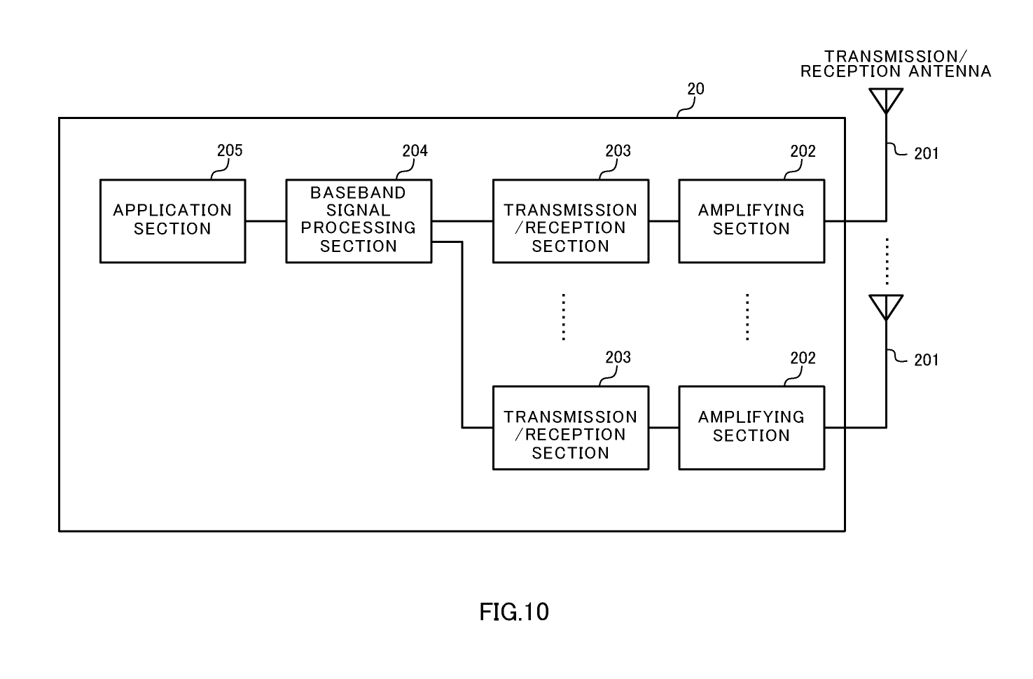

Entire configurations of the radio base station 10 and user terminal 20 will be described with reference to FIGS. 9 and 10. FIG. 9 is an entire configuration diagram of the radio base station 10 according to this Embodiment. As shown in FIG. 9, the radio base station 10 is provided with a plurality of transmission/reception antennas 101 for MIMO transmission, amplifying sections 102, transmission/reception sections 103 (transmission section, reception section), baseband signal processing section 104, call processing section 105, and transmission path interface 106.

User data to transmit to the user terminal 20 from the radio base station 10 on downlink is input to the baseband signal processing section 104 from the core network 30 via the transmission path interface 106.

The baseband signal processing section 104 performs, on the input user data, processing of PDCP (Packet Data Convergence Protocol) layer, segmentation and concatenation of the user data, transmission processing of RLC (Radio Link Control) layer such as transmission processing of RLC retransmission control, MAC (Medium Access Control) retransmission control, for example, transmission processing of HARQ (Hybrid Automatic Repeat reQuest), scheduling, transmission format selection, channel coding, Inverse Fast Fourier Transform (IFFT) processing, precoding processing, CP (Cyclic Prefix) insertion processing and the like to transfer to each of the transmission/reception sections 103. Further, also concerning a downlink control signal (including a reference signal, synchronization signal, broadcast signal and the like), the section 104 performs transmission processing such as channel coding and Inverse Fast Fourier Transform on the signal to transfer to each of the transmission/reception sections 103.

Each of the transmission/reception sections 103 converts the downlink signal, which is subjected to precoding for each antenna and is output from the baseband signal processing 104, into a signal with a radio frequency. The amplifying sections 102 amplify the radio-frequency signal subjected to frequency conversion, and transmit from the transmission/reception antennas 101.

On the other hand, for an uplink signal, a radio-frequency signal received in each of the transmission/reception antennas 101 is amplified in respective one of the amplifying sections 102, is subjected to frequency conversion in respective one of the reception sections 103 and is thereby converted into a baseband signal, and the signal is input to the baseband signal processing section 104.

For user data included in the input uplink signal, the baseband signal processing section 104 performs CP removing processing, FFT processing, IDFT processing, error correcting decoding, reception processing of MAC retransmission control, and reception processing of RLC layer and PDCP layer to transfer to the core network 30 via the transmission path interface 106. The call processing section 105 performs call processing such as setting and release of a communication channel, state management of the radio base station 10, and management of radio resources.

FIG. 10 is an entire configuration diagram of the user terminal 20 according to this Embodiment. The user terminal 20 is provided with a plurality of transmission/reception antennas 201 for MIMO transmission, amplifying sections 202, transmission/reception sections 203 (transmission section, reception section), baseband signal processing section 204, and application section 205.

For a downlink signal, radio-frequency signals received in a plurality of transmission/reception antennas 201 are respectively amplified in the amplifying sections 202, are subjected to frequency conversion in the transmission/reception sections 203, and are input to the baseband signal processing section 204. The baseband signal processing section 204 performs CP removing processing, FFT processing, error correcting decoding, reception processing of retransmission control and the like. User data included in the downlink signal is transferred to the application section 205. The application section 205 performs processing concerning layers higher than physical layer and MAC layer, and the like. Further, among the downlink data, broadcast information is also transferred to the application section 205.

On the other hand, for uplink user data, the data is input to the baseband signal processing section 204 from the application section 205. The baseband signal processing section 204 performs transmission processing of retransmission control (H-ARQ (Hybrid ARQ)), channel coding, precoding, DFT processing, IFFT processing, CP insertion processing and the like to transfer to each of the transmission/reception sections 203. Each of the transmission/reception sections 203 converts the baseband signal output from the baseband signal processing section 204 into a signal with a radio frequency. Subsequently, each of the amplifying sections 202 amplifies the radio-frequency signal subjected to frequency conversion to transmit from respective one of the transmission/reception antennas 201.

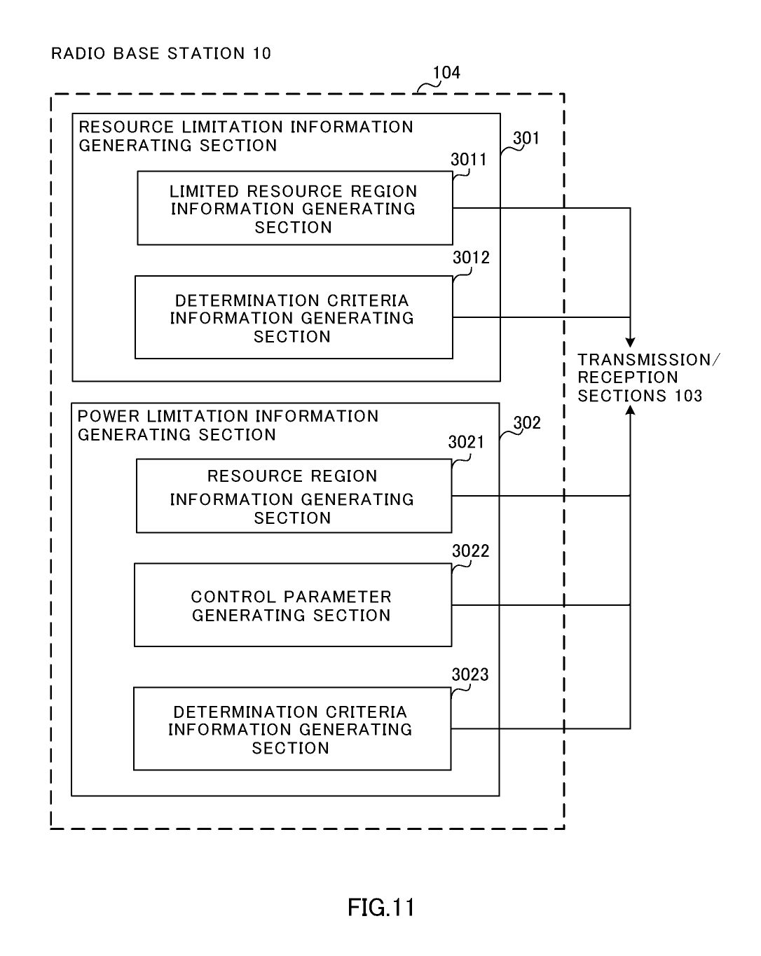

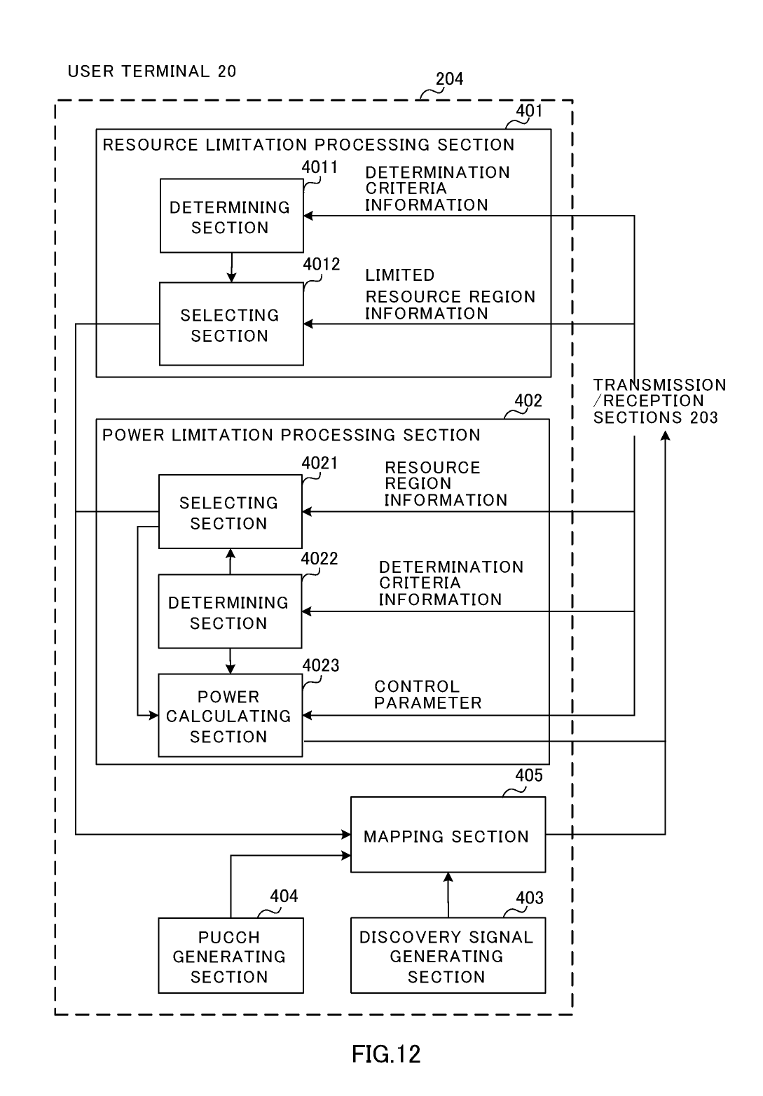

Detailed configurations of the radio base station 10 and user terminal 20 will be described next with reference to FIGS. 11 and 12. The function configuration of the radio base station 10 as shown in FIG. 11 is mainly comprised of the baseband signal processing section 104 of FIG. 9. Further, the detailed configuration of the user terminal 20 as shown in FIG, 12 is mainly comprised of the baseband signal processing section 204 of FIG. 10.

FIG. 11 is a detailed configuration diagram of the radio base station 10 according to this Embodiment. As shown in FIG. 11, the radio base station 10 is provided with a resource limitation information generating section 301 (generating section) and power limitation information generating section 302 (generating section). In addition, the resource limitation information generating section 301 may be omitted in Aspect 2 of the present invention. Further, the power limitation information generating section 302 may be omitted in Aspect 1 of the invention.

The resource limitation information generating section 301 generates resource limitation information (Aspect 1). The resource limitation information is information to limit the allocation resource of the discovery signal, and includes the limited resource region information and determination criteria information as described later. Specifically, the resource limitation information generating section 301 is provided with a limited resource region information generating section 3011 and determination criteria information generating section 3012.

The limited resource region information generating section 3011 generates the limited resource region information indicative of the limited resource region. The limited resource region is a resource region obtained by removing an adjacent region of a frequency resource region (PUCCH region) where the PUCCH is allocated. For example, when the PUCCH region is provided in opposite end regions of the band, the limited resource region may be within a predetermined range from the center frequency of the band, and a resource region obtained by removing adjacent regions of the PUCCH region (see FIG. 4B). For example, the limited resource region information may be an index (for example, resource block index, PRB index and the like) of the radio resource forming the limited resource region.

The limited resource region information generating section 3011 outputs the generated limited resource region information to the transmission/reception sections 103. The limited resource region information is transmitted from the transmission/reception section 103 to the user terminal 20, using broadcast information such as SIB, downlink control channel (PDCCH or EPDCCH), higher layer signaling such as RRC signaling and the like.

The determination criteria information generating section 3012 generates the determination criteria information used in the determination of the distance between the user terminal and the radio base station. As described above, for example, the determination criteria information is predetermined thresholds with respect to path loss and downlink signal intensity.

The determination criteria information generating section 3012 outputs the generated determination criteria information to the transmission/reception sections 103. The determination criteria information is transmitted from the transmission/reception section 103 to the user terminal 20, using broadcast information such as SIB, downlink control channel (PDCCH or EPDCCH), higher layer signaling such as RRC signaling and the like. In addition, when the determination criteria information is beforehand stored in the user terminal 20, the determination criteria information generating section 3012 may be omitted.

The power limitation information generating section 302 generates power limitation information (Aspect 2). The power limitation information is information to limit transmission power of the discovery signal, and includes at least one of the resource region information, control parameter, and determination criteria information as described later. Specifically, the power limitation information generating section 302 is provided with a resource region information generating section 3021, control parameter generating section 3022, and determination criteria information generating section 3023.

The resource region information generating section 3021 transmits the resource region information indicative of a plurality of resource regions (also referred to as resource set) with different frequency distances from the PUCCH region. As described above, a plurality of resource regions is resource regions divided (frequency division multiplexed) corresponding to the frequency distance (for example, the number of resource blocks) from the PUCCH region, and is also called the resource set (see FIG. 5B). For example, the resource region information is an index (for example, resource block index, PRB index and the like) of the radio resource forming each resource region.

The resource region information generating section 3021 outputs the generated resource region information to the transmission/reception sections 103. The resource region information is transmitted from the transmission/reception section 103 to the user terminal 20, using broadcast information such as SIB, downlink control channel (PDCCH or EPDCCH), higher layer signaling such as RRC signaling and the like.

The control parameter generating section 3022 generates a control parameter of transmission power of the discovery signal. The control parameter may include maximum allowable power (X1, X2 in FIG. 5B) of the discovery signal that is different for each resource region (Aspect 2.1).

Alternatively, the control parameter may include predetermined transmission power (X1 in FIG. 6B) that is not dependent on each resource region and the predetermined coefficient (K in FIG. 6B) (Aspect 2.2).

Alternatively, the control parameter may include the transmission power offset (X in FIG. 7B) different for each resource region, and the control parameter (for example, transmission power offset (P_{O}_{_}_{PUCCH}, P_{O}_{_}_{PUSCH} (j)), TPC command the like) of transmission power of the PUCCH or the PUSCH (Aspect 2.3).

The control parameter generating section 3022 outputs the generated control parameter to the transmission/reception sections 103. The control parameter is transmitted from the transmission/reception section 103 to the user terminal 20, using broadcast information such as SIB, downlink control channel (PDCCH or EPDCCH), higher layer signaling such as RRC signaling and the like.

The determination criteria information generating section 3023 generates the determination criteria information used in the determination of the distance between the user terminal and the radio base station, as the determination criteria information generating section 3012. The detailed processing of the determination criteria information generating section 3023 is the same as that of the determination criteria information generating section 3012, and therefore, descriptions thereof are omitted. In addition, when a determining section 4022 is omitted in a power limitation processing section 402 of the user terminal 20, the determination criteria information generating section 3023 may be omitted.

FIG. 12 is a detailed configuration diagram of the user terminal 20 according to this Embodiment. As shown in FIG. 12, the user terminal 20 is provided with a resource limitation processing section 401, power limitation processing section 402, discovery signal generating section 403, PUCCH generating section 404, and mapping section (allocation section) 405. In addition, the resource limitation processing section 401 may be omitted in Aspect 2 of the present invention. Further, the power limitation processing section 402 may be omitted in Aspect 1 of the invention.

The resource limitation processing section 401 performs processing for limiting the allocation resource of the discovery signal corresponding to the distance between the radio base station 10 and the user terminal 20 (Aspect 1). Specifically, the resource limitation processing section 401 is provided with a determining section 4011 and selecting section 4012.

The determining section 4011 determines the distance (position of the user terminal 20 in the cell C) between the radio base station 10 and the user terminal 20. The determining section 4011 may determine the distance between the radio base station 10 and the user terminal 20, based on the determination criteria information (for example, predetermined thresholds with respect to downlink signal intensity and path loss) received from the radio base station 10 in the transmission/reception section 203. The determination criteria information may be received in the transmission/reception section 203 using broadcast information such as SIB, downlink control channel (PDCCH or EPDCCH), higher layer signaling such as RRC signaling and the like and input to the determining section 4011, or may be beforehand stored in the user terminal 20.

Specifically, the determining section 4011 may determine the distance from the radio base station 10, based on a comparison result between a predetermined threshold and received signal intensity (for example, RSRP) of a downlink signal from the radio base station 10. For example, the determining section 401 may determine that the distance from the radio base station 10 is relatively far (positioned in the cell edge portion) when the downlink signal intensity is lower than the predetermined threshold, and may determine that the distance from the radio base station 10 is relatively close (positioned in the cell center portion) when the downlink signal intensity is the predetermined threshold or more.

Further, the determining section 4011 may determine the distance from the radio base station 10, based on a comparison result between a predetermined threshold and path loss calculated based on received signal intensity of a downlink signal from the radio base station 10. For example, the determining section 4011 may determine that the distance from the radio base station 10 is relatively far (positioned in the cell edge portion) when the above-mentioned path loss is larger than the predetermined threshold, and may determine that the distance from the radio base station 10 is relatively close (positioned in the cell center portion) when the above-mentioned path loss is the predetermined threshold or less.

Based on the determination result in the determining section 4011, the selecting section 4012 selects the allocation resource of the discovery signal. Specifically, when the determining section 4011 determines that the distance from the radio base station 10 is relatively close (positioned in the cell center portion), the selecting section 4012 selects the allocation resource of the discovery signal from the limited resource region indicated by the limited resource region information.

On the other hand, when the determining section 4011 determines that the distance from the radio base station 10 is relatively far (positioned in the cell edge portion), the selecting section 4012 selects the allocation resource of the discovery signal from the D2D region formed of the limited resource region indicated by the limited resource region information and adjacent regions of the PUCCH region.

In addition, the limited resource region information is received in the transmission/reception section 203 using broadcast information such as SIB, downlink control channel (PDCCH or EPDCCH), higher layer signaling such as RRC signaling and the like, and is input to the selecting section 4012.

The power limitation processing section 402 performs processing for limiting transmission power of the discovery signal corresponding to the allocation resource of the discovery signal (Aspect 2). Specifically, the power limitation processing section 402 is provided with a selecting section 4021, determining section 4022, and power calculating section 4023. In addition, the determining section 4022 may be omitted.

The selecting section 4021 selects the allocation resource of the discovery signal. Specifically, the section may select the allocation resource of the discovery signal from a plurality of resource regions indicated by the resource region information received in the transmission/reception section 203 (Aspect 2.1). As described above, in the plurality of resource regions, the frequency distance from the PUCCH region is different from one another (see FIG. 5B). Further, the resource region information is received in the transmission/reception section 203 using broadcast information such as SIB, downlink control channel (PDCCH or EPDCCH), higher layer signaling such as RRC signaling and the like, and is input to the selecting section 4021.

Further, the selecting section 4021 may select the allocation resource (for example, resource block) to allocate the discovery signal from the D2D region, without being based on the above-mentioned resource region information (Aspects 2.2 and 2.3).

Furthermore, the selecting section 4021 may select the allocation resource of the discovery signal, based on a determination result by the determining section 4022 described later. Alternatively, the selecting section 4021 may select the allocation resource of the discovery on an arbitrary condition (for example, autonomously or randomly).

The determining section 4022 determines the distance (position of the user terminal 20 in the cell C) between the radio base station 10 and the user terminal 20, as the above-mentioned determining section 4011. The detailed processing of the determining section 4022 is the same as in the above-mentioned determining section 4011, and therefore, descriptions thereof are omitted. In addition, the determining section 4022 may be omitted.

The power calculating section 4023 calculates transmission power of the discovery signal, based on the allocation resource (more specifically, frequency distance between the allocation resource and the PUCCH region) of the discovery signal selected by the selecting section 4021.

For example, when maximum allowable power different for each resource region is determined (Aspect 2.1, FIG. 5B), based on maximum allowable power of the resource region including the allocation resource selected by the selecting section 4021, the power calculating section 4023 calculates transmission power of the discovery signal. Further, the calculating section 4023 may calculate transmission power of the discovery signal, based on maximum allowable power of the resource region and the distance (path loss) from the radio base station 10 determined by the determining section 4022 (FIG. 5B).

In addition, maximum allowable power (X1, X2 in FIG. 5B) different for each resource region may be included in the control parameter received in the transmission/reception section 203, or may be beforehand stored in the user terminal 20.

Further, in the case of calculating maximum allowable power based on the frequency distance from the PUCCH region (Aspect 2.2, FIG. 6B), based on calculated maximum allowable power, the power calculating section 4023 calculates transmission power of the discovery signal. Further, the power calculating section 4023 may calculate transmission power of the discovery signal, based on the maximum allowable power and the distance (path loss) from the radio base station 10 determined by the determining section 4022 (FIG. 6B).

In addition, the maximum allowable power (X1+K×D1, X1+K×D2 in FIG. 6B) is calculated by the power calculating section 4023, based on predetermined transmission power X1 that is not dependent on the resource region, predetermined coefficient K, and frequency distances (for example, the number of resource blocks) D1, D2 from the PUCCH region. Herein, the above-mentioned X1 and K may be included in the control parameter received in the transmission/reception section 203, or may be beforehand stored in the user terminal 20.

Further, when the user terminal 20 is in the connected state (RRC_connected state) (Aspect 2.3, FIG. 7B), the power calculating section 4023 calculates transmission power of the discovery signal, based on transmission power of the PUCCH or the PUSCH, and the transmission power offset with respect to the transmission power of the PUCCH or the PUSCH.

In addition, the transmission power offset (X in FIG. 7B) may be included in the control parameter received in the transmission/reception section 203, or may be beforehand stored in the user terminal 20.

The discovery signal generating section 403 generates the discovery signal. The discovery signal is an inter-terminal discovery signal for causing another user terminal to discover the terminal by bypassing the radio base station, and may include identification information of the terminal. The discovery signal may be called the D2D signal, D2D discovery signal, DS and the like.

The PUCCH generating section 404 generates the uplink control channel (PUCCH). Specifically, the PUCCH generating section 404 performs coding, modulation and the like on the uplink control channel to output to the mapping section 405.

The mapping section 405 allocates (maps) the discovery signal generated in the discovery signal generating section 403 and the PUCCH generated in the PUCCH generating section 404 to radio resources. Specifically, the mapping section 405 maps (allocates) the discovery signal to the allocation resource selected by the selecting section 4012 or 4021. Further, the mapping section 405 maps (allocates) the PUCCH to radio resources of the PUCCH region.

The transmission/reception section 203 performs frequency division multiplexing on the discovery signal and PUCCH mapped to radio resources by the mapping section 405 to transmit.

According to the radio communication system 1 according to this Embodiment, in the case of performing frequency division multiplexing on the PUCCH allocated to opposite end regions of the band and the discovery signal, it is possible to reduce interference (in-band emission) to the PUCCH by the discovery signal.

Specifically, in the radio communication system 1, when the distance between the radio base station 10 and the user terminal 20 is relatively close (user terminal 20 is positioned in the cell center portion), the allocation resource of the discovery signal is selected from the limited resource region spaced apart from the PUCCH region, and it is thereby possible to reduce interference to the PUCCH by the discovery signal (Aspect 1).

Further, in the radio communication system 1, transmission power of the discovery signal is limited corresponding to the allocation resource (more specifically, the frequency distance between the allocation resource of the discovery signal and the PUCCH region) of the discovery signal, and it is thereby possible to reduce interference to the PUCCH by the discovery signal (Aspect 2).

As described above, the present invention is specifically described using the above-mentioned Embodiment, but it is obvious to a person skilled in the art that the invention is not limited to the Embodiment described in the Description. The invention is capable of being carried into practice as modified and changed aspects without departing from the subject matter and scope of the invention defined by the descriptions of the scope of the claims. Accordingly, the descriptions of the Description are intended for illustrative explanation, and do not have any restrictive meaning to the invention.

The present application is based on Japanese Patent Application No. 2014-016064 filed on Jan. 30, 2014, entire content of which is expressly incorporated by reference herein.

1. A user terminal that performs frequency division multiplexing on an uplink control channel and an inter-terminal discovery signal to transmit, comprising:
a reception section that receives limited resource region information indicative of a limited resource region obtained by removing an adjacent region of a frequency resource region where the uplink control channel is allocated from a radio base station;
a determining section that determines a distance between the radio base station and the user terminal; and
a selecting section that selects an allocation resource of the inter-terminal discovery signal from the limited resource region, when the determining section determines that the distance is relatively close.

2. The user terminal according to claim 1, wherein when the determining section determines that the distance is relatively far, the selecting section selects the allocation resource of the inter-terminal discovery signal from a resource region formed of the limited resource region and the adjacent region.

3. The user terminal according to claim 1, wherein the reception section receives the limited resource region information, using one of broadcast information, a downlink control channel and higher layer signaling.

4. The user terminal according to claim 1, wherein the determining section determines the distance, based on a comparison result between received signal intensity of a downlink signal from the radio base station and a predetermined threshold.

5. The user terminal according to claim 1, wherein the determining section determines the distance, based on a comparison result between a path loss calculated based on received signal intensity of a downlink signal from the radio base station and a predetermined threshold.

6. The user terminal according to claim 4, wherein the reception section receives the predetermined threshold, using one of broadcast information, a downlink control channel and higher layer signaling.

7. The user terminal according to claim 1, further comprising:
a transmission section that transmits the inter-terminal discovery signal, using certain transmission power or transmission power limited corresponding to the selected allocation resource.

8. A radio base station that receives an uplink control channel frequency division multiplexed with an inter-terminal discovery signal from a user terminal, comprising:
a generating section that generates limited resource region information indicative of a limited resource region obtained by removing an adjacent region of a frequency resource region where the uplink control channel is allocated; and
a transmission section that transmits the limited resource region information to the user terminal.

9. (canceled)

10. A radio communication method in a radio communication system where a user terminal performs frequency division multiplexing on an uplink control channel and an inter-terminal discovery signal to transmit, comprising:
in a radio base station, transmitting limited resource region information indicative of a limited resource region obtained by removing an adjacent region of a frequency resource region where the uplink control channel is allocated;
in the user terminal, determining a distance between the radio base station and the user terminal; and
selecting an allocation resource of the inter-terminal discovery signal from the limited resource region indicated by the limited resource region information, when it is determined that the distance is relatively close.

11. The user terminal according to claim 2, wherein the reception section receives the limited resource region information, using one of broadcast information, a downlink control channel and higher layer signaling.

12. The user terminal according to claim 2, wherein the determining section determines the distance, based on a comparison result between received signal intensity of a downlink signal from the radio base station and a predetermined threshold.

13. The user terminal according to claim 2, wherein the determining section determines the distance, based on a comparison result between a path loss calculated based on received signal intensity of a downlink signal from the radio base station and a predetermined threshold.

14. The user terminal according to claim 2, further comprising:
a transmission section that transmits the inter-terminal discovery signal, using certain transmission power or transmission power limited corresponding to the selected allocation resource.

15. The user terminal according to claim 6, further comprising:
a transmission section that transmits the inter-terminal discovery signal, using certain transmission power or transmission power limited corresponding to the selected allocation resource.
